(19) United States
(12) Patent Application Publication
(10) Pub. No.: US 2011/0179448 A1
(43) Pub. Date: Jul. 21, 2011

(54) SYSTEM AND METHOD FOR PROVIDING USER SPECIFICATION OF ADVERTISING CONTENT

(76) Inventors: Jeyhan Karaoguz, Irvine, CA (US); Nambirajan Seshadri, Irvine, CA (US); Henry Samueli, Corona Del Mar, CA (US)

(21) Appl. No.: 12/948,954

(22) Filed: Nov. 18, 2010

Related U.S. Application Data
(60) Provisional application No. 61/295,314, filed on Jan. 15, 2010.

(51) Int. Cl. H04N 7/025

(52) U.S. Cl. 725/34

(57) ABSTRACT

A system and method for providing user specification of advertising content, substantially as shown in and/or described in connection with at least one of the figures, as set forth more completely in the claims.

### CROSS-REFERENCE TO RELATED APPLICATIONS/INCORPORATION BY REFERENCE

This patent application is related to and claims priority from provisional patent application Ser. No. 61/295,314 filed Jan. 15, 2010, and titled “SYSTEM AND METHOD FOR PROVIDING USER SPECIFICATION OF ADVERTISING CONTENT,” the contents of which are hereby incorporated herein by reference in their entirety. This patent application is also related to U.S. patent application Ser. No. __/___,___, filed concurrently herewith, titled “SYSTEM AND METHOD IN A PROGRAM RECORDER FOR MANAGING ADVERTISEMENT PRESENTATION”, Attorney Docket No. 21194US02; U.S. patent application Ser. No. __/___,___, filed concurrently herewith, titled “SYSTEM AND METHOD FOR UPDATING ADVERTISING CONTENT FOR A RECORDED PROGRAM”, Attorney Docket No. 21195US02; U.S. patent application Ser. No. __/___,___, filed concurrently herewith, titled “SYSTEM AND METHOD FOR MONITORING AND REPORTING PRESENTATION OF RECORDED ADVERTISING CONTENT”, Attorney Docket No. 21197US02; U.S. patent application Ser. No. __/___,___, filed concurrently herewith, titled “SYSTEM AND METHOD FOR PROVIDING VIEWER IDENTIFICATION-BASED ADVERTISING”, Attorney Docket No. 21198US02; and U.S. patent application Ser. No. __/___,___, filed concurrently herewith, titled “SYSTEM AND METHOD FOR COMMUNICATING PROGRAMMING AND ADVERTISING CONTENT THROUGH DIVERSE COMMUNICATION NETWORKS”, Attorney Docket No. 21199US02. The contents of each of the above-mentioned applications are hereby incorporated herein by reference in their entirety.

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

Users are generally provided with advertising content that is associated with a particular program. Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

Various aspects of the present invention provide a system and method for providing user specification of advertising content, substantially as shown in and/or described in connection with at least one of the figures, as set forth more completely in the claims. These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 shows a non-limiting exemplary flow diagram of a method for providing user specification of advertising content, in accordance with various aspects of the present invention.

FIG. 2 shows a non-limiting exemplary flow diagram of a method for providing user specification of advertising content, in accordance with various aspects of the present invention.

FIG. 3 is a diagram illustrating an exemplary video content distribution environment.

FIG. 4 is a diagram illustrating various non-limiting aspects of exemplary user equipment, in accordance with various aspects of the present invention.

FIG. 5 is a diagram illustrating exemplary modules and/or sub-modules for user equipment, in accordance with various aspects of the present invention

### DETAILED DESCRIPTION OF VARIOUS ASPECTS OF THE INVENTION

The following discussion will refer to various communication modules, components or circuits. Such modules, components or circuits may generally comprise hardware and/or a combination of hardware and software (e.g., including firmware). Such modules may also, for example, comprise a computer readable medium (e.g., a non-transitory medium) comprising instructions (e.g., software instructions) that, when executed by a processor, cause the processor to perform various functional aspects of the present invention. Accordingly, the scope of various aspects of the present invention should not be limited by characteristics of particular hardware and/or software implementations of a module, component or circuit unless explicitly claimed as such. For example and without limitation, various aspects of the present invention may be implemented by one or more processors (e.g., a microprocessor, digital signal processor, baseband processor, microcontroller, etc.) executing software instructions (e.g., stored in volatile and/or non-volatile memory). Also for example, various aspects of the present invention may be implemented by an application-specific integrated circuit (“ASIC”) and/or other hardware components.

Additionally, the following discussion will refer to various system modules (e.g., user equipment modules). It should be noted that the following discussion of such various modules is segmented into such modules for the sake of illustrative clarity. However, in actual implementation, the boundaries between various modules may be blurred. For example, any or all of the functional modules discussed herein may share various hardware and/or software components. For example, any or all of the functional modules discussed herein may be implemented wholly or in-part by a shared processor executing software instructions. Additionally, various software sub-modules that may be executed by one or more processors may be shared between various software modules. Accordingly, the scope of various aspects of the present invention should not be limited by arbitrary boundaries between various hardware and/or software components, unless explicitly claimed.

The following discussion may also refer to communication networks and various aspects thereof. For the following discussion, a communication network is generally the communication infrastructure through which a communication device (e.g., a video recorder, a personal video recorder, an electronic device with video presentation capability, a television receiver, a television, a television controller, a portable communication device, a video content provider, a television program provider, an advertising video provider, a data network communication service provider, etc.) may communicate with other systems. For example and without limitation, a communication network may comprise a cable and/or satellite television communication network, a cellular communication network, a telecommunication network, a general data communication network (e.g., the Internet) a wireless metropolitan area network (WMAN), a wireless local area network (WLAN), a wireless personal area network (WPAN), any home or premises communication network, etc. A particular communication network may, for example, generally have a corresponding communication protocol according to which a device (e.g., user equipment comprising an electronic device with video recording capability) may communicate with the communication network. Unless so claimed, the scope of various aspects of the present invention should not be limited by characteristics of a particular type of communication network and/or communication protocol.

Additionally, the following discussion will at times refer to video content. Such video content may, for example, comprise various types of television programming (e.g., television programs, news programs, sports programs, music television, movies, television series programs, educational programs, live or recorded television programming, broadcast/multicast/unicast television programming, etc.). Such video content may, for example, comprise real-time television broadcast programming (or multicast or unicast television programming) and/or user-stored television programming that is stored in user equipment (e.g., a VCR, PVR, etc.). Such video content may also, for example, comprise advertising video content (e.g., an audio/video commercial, a still image advertisement, a user-interactive advertisement, advertising content embedded in and/or separate from television programming, etc.). Such video content may also, for example, comprise graphical and/or textual content that may be displayed on a television screen (e.g., an electronic program guide, user interface menu, a television set-up menu, a typical web page, a document, a graphical video game, etc.).

Further, the following discussion will at times refer to advertised products. The term “product” will be used generally to include at least goods and services (e.g., consumer goods and/or services).

Users are often provided with advertising content associated with a presented television program in a one-to-one relationship. Characteristics of such advertising content may, for example, vary with respect to the corresponding program and/or type of program with which such advertising content is presented. For example, football programming is often accompanied with beer and truck commercials, late night talk shows are often associated with adult-oriented advertisements, afternoon soap operas are often associated with domestic care products.

In such scenarios, users are subjected to advertising content based on gross generalizations about user interest associated with the programming. In reality, however, a substantial amount of users viewing a particular program may not fit the stereotyping utilized by programming providers to target advertisements to user groups.

Additionally, parents have little control over the type of advertising content viewed by their children. For example, parents watching football with their children will necessarily subject their children to beer commercials. Parents watching late night television (whether in real-time or in a time-shifted manner) will subject their children to advertisements for adult-oriented products.

In accordance with various aspects of the present invention, a user may specify characteristics of advertisements to be presented to the user. Conversely, a user may specify characteristics of advertisements that should not be presented to the user. Various aspects of the present invention may, for example in user equipment (e.g., an electronic device comprising video playing capability), comprise providing a user interface by which a user may input characteristics of advertising content, selecting advertising for presentation to a user based at least in part on the user-input characteristics, and presenting the selected advertising. Note that in alternative embodiments any or all of the functionality discussed herein may also be performed by equipment associated with video content sources and/or communicators.

The following discussion will provide various non-limiting examples of respective aspects of the present invention. Accordingly, the scope of various aspects of the present invention should not be limited by characteristics of such non-limiting examples unless explicitly claimed.

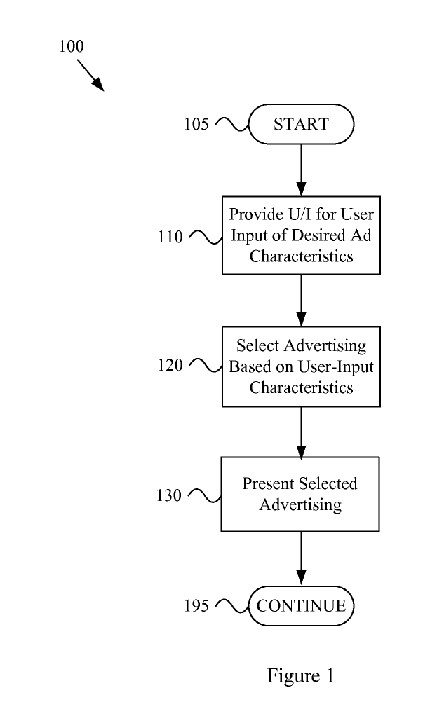

Turning first to FIG. 1, such figure illustrates a non-limiting exemplary flow diagram of a method 100 for providing user specification of advertising content, in accordance with various aspects of the present invention. Any or all aspects of the exemplary method 100 may, for example, be implemented in user equipment (e.g., a personal video recorder, a television receiver (or set top box) with or without video recording capability, a gaming device, a personal computing device (e.g., handheld, notebook, laptop, desktop, etc.), etc. Also, as mentioned above, any or all aspects of the exemplary method 100 may be performed by non-user equipment (e.g., network video content server apparatus, communication network infrastructure apparatus, etc.).

The exemplary method 100 may begin executing at step 105. The method 100 may begin executing in response to any of a variety of causes and/or conditions, non-limiting examples of which will now be provided. For example, the exemplary method 100 may begin executing in response to a received user input command to immediately specify advertising characteristics (e.g., for a single television viewing session, for an advertising profile associated with the user and/or user equipment and/or household, etc.). Also for example, the exemplary method 100 may begin executing in response to a timer (e.g., periodically). Additionally for example, the exemplary method 100 may begin executing in response to resetting (or initially configuring) operation of apparatus implementing the method 100. Further for example, the exemplary method 100 may begin executing in response to receiving a request from a video content provider (e.g., a television program provider, an advertising content provider, etc.).

The exemplary method 100 may, for example at step 110, comprise providing a user interface by which a user may input characteristics of advertising content. For example, step 110 may comprise providing a user interface by which a user may input characteristics of advertising content desired (or allowed) by the user.

Such user interface may, for example, comprise any of a variety of user interface characteristics, non-limiting examples of which will now be provided. For example, the user interface may comprise characteristics of a graphical user interface. Such a graphical user interface may, for example, be provided on a television screen of a user home media system (e.g., a screen of user equipment implementing the method 100, a television screen communicatively coupled to user equipment implementing the method 100, a screen of a remote control device communicatively coupled to user equipment implementing the method 100, etc.). Such a graphical user interface may, for example, be provided on a screen of a personal electronic device (e.g., a personal computing device, a cellular telephone, a personal digital assistant, a notebook computer, a laptop or desktop computer system, etc.). In such scenarios, the user may then interact with the graphical user interface in a manner corresponding to the respective type of graphical user interface provided to the user (e.g., utilizing a keypad, utilizing a touch screen, utilizing a cursor moving mechanism, etc.). Such a graphical user interface may, for example, comprise characteristics of a menu-based system, in which a user may select (e.g., from a predetermined list) advertising content characteristics, time characteristics, priority characteristics, etc.).

Also for example, such user interface may comprise characteristics of one or more dedicated buttons (e.g., on a media controller). For example, a button may (e.g., temporarily and/or permanently) be assigned to functionality related to user-specification of advertising content characteristics. For example, as will be discussed below, a user may flag a particular advertisement as desirable (e.g., for repeated viewing) or as undesirable (e.g., for future blocking). Such flagging may, for example, be performed by pressing a single button (e.g., during play of the advertisement) on a controller, by selecting an icon overlaid on the advertisement while the advertisement is presented, etc.).

In general, step 110 may comprise providing any of a variety of different general types of user interfaces to the user. Accordingly, the scope of various aspects of the present invention should not be limited by characteristics of a particular general type of user interface unless explicitly claimed.

The user interface provided at step 110 may comprise user interface features by which a user may input (or specify) any of a variety of characteristics of advertising content, non-limiting examples of which will now be provided.

For example, the input characteristics of advertising content may comprise information identifying a specific type of product. For example, step 110 may comprise providing a user (e.g., of user equipment implementing the method 100 or a portion thereof) with a user interface that provides a convenient mechanism by which the user may identify one or more types of products for which the user desires to view advertisements.

For example, in an exemplary scenario, a user may have an interest in viewing automobile commercials, consumer electronics commercials, television commercials, telephone commercials, beverage commercials, entertainment event commercials, home improvement product commercials, hair care product commercials, clothing commercials, toy commercials, etc. For example, step 110 may comprise presenting a graphical user interface comprising a list of selectable product types (or general product categories) from which the user may select one or more product types of interest to the user.

Also for example, the input characteristics of advertising content may comprise information identifying a specific product. For example, step 110 may comprise providing a user (e.g., of user equipment implementing the method 100 or a portion thereof) with a user interface that provides a convenient mechanism by which the user may specify products for which the user desires to view advertisements.

For example, in an exemplary scenario, a user may have an interest in viewing automobile commercials for a particular make of vehicle, consumer electronics commercials for a particular television receiver with user ad control capability, commercials for a particular financial services provider, commercials for a particular type of beer or other beverage, commercials for a particular toy, commercials for a particular article of clothing, commercials for a particular service, etc. For example, step 110 may comprise presenting a graphical user interface comprising a list (e.g., a multilayer nested list) of selectable products from which the user may select one or more products of interest to the user.

Additionally for example, the input characteristics of advertising content may comprise information identifying a particular provider (or source) of an advertised product. Such a provider may, for example, be a manufacturer and/or distributor of a consumer good, a provider of a consumer service, etc.

For example, in an exemplary scenario, a user may have an interest in products provided by a particular manufacturer, distributer, retailer or provider, the user may have an interest in products produced by manufacturers in a particular geographical region, the user may have an interest in products provided by retailers located within a particular distance of the user's home, etc. For example, step 110 may comprise presenting a graphical user interface comprising a list of selectable product providers from which the user may select one or more product sources of interest to the user.

Additionally for example, the input characteristics of advertising content may comprise information identifying a general style (or type) of advertising content. Such a general style (or type) may, for example, be independent of a particular product (or product type) being advertised. For example, such a style may comprise characteristics of an advertisement genre.

For example, a user may have an interest in one or more general advertising styles. For example, a user may specify a desire to be presented with humorous advertisements, advertisements of an adult nature, family-oriented advertising, advertisements including beach scenes, advertisements of a spiritual nature, advertisements including nature scenes, action-packed advertisements, etc. For example, step 110 may comprise presenting a graphical user interface comprising a list of selectable general advertisement styles from which the user may select one or more styles of interest to the user.

Also for example, the input characteristics of advertising content may comprise information identifying a specific advertisement. For example, step 110 may comprise providing a user (e.g., of user equipment implementing the method 100 or a portion thereof) with a user interface that provides a convenient mechanism by which the user may specify a particular advertisement that the user would like to view again.

For example, in an exemplary scenario, a user may view an advertisement that the user considers to be interesting, entertaining, humorous, immediately relevant to the user, of a general type that is of interest to the user, etc. In such a scenario, step 110 may comprise presenting a graphical user interface by which the user may identify (or flag) the advertisement for future viewing. For example, step 110 may comprise presenting the user with a selectable list of recently presented advertisements from which the user may select a desired advertisement.

Also for example, step 110 may comprise providing a button (e.g., a remote control button, a button on a personal portable electronic device, etc.) that when pressed, flags a particular advertisement (e.g., an advertisement currently being presented) as desirable for future viewing. Such a button may, for example, be temporarily dedicated to such operation, but may also be permanently dedicated to such operation.

In various exemplary scenarios, such specification of a particular advertisement by a user may result in (e.g., at step 120) the selected advertisement(s) being immediately replayed, replayed at the next commercial break, generally repeated in the future at a higher than normal repetition rate for such advertisement, etc.

For example, the input characteristics of advertising content may comprise time information associated with advertising content. For example, step 110 may comprise providing a user (e.g., of user equipment implementing the method 100 or a portion thereof) with a user interface that provides a convenient mechanism by which the user may specify a time window associated with presentation of particular advertising content. As will be discussed in more detail below, such time window information may be utilized to filter out particular advertising content that the user specifies is not to be presented during such time window and/or to time-shift particular advertising content to a time window during which the user has indicated such advertising content is desirable (or allowable).

For example, in an exemplary scenario, a user may specify a desire for alcoholic beverage commercials, but only during late evening hours. A user may similarly, for example, specify a desire for family-oriented commercials and toy commercials, but only during mornings and afternoons. Also for example, a user may specify that vehicle commercials are preferable any time of day. A user may also, for example, identify a specific commercial (e.g., a commercial being presently provided to the user) for presentation at a particular time or time range. For example, step 110 may comprise presenting a graphical user interface comprising a list of times from which the user may select (or define) respective time constraints for presentation of advertisements (e.g., for particular products, particular types of products, particular sources of products, particular general styles of advertisements, particular specifically-identified advertisements, etc.).

Still further for example, the input characteristics of advertising content may comprise prioritization information associated with advertising content. For example, step 110 may comprise providing a user (e.g., of user equipment implementing the method 100 or a portion thereof) with a user interface that provides a convenient mechanism by which the user may specify priority associated with presentation of particular advertising content. For example, a user may specify a relatively high priority (i.e., a higher-than-normal priority) for advertising content for products in which the user has relatively high interest. Such prioritization may, for example, be utilized to provide preferred advertising content to the user while not necessarily eliminating all lower-priority advertisements.

For example, in an exemplary scenario, a user may specify that toy commercials have the lowest priority. A user may similarly, for example, specify that home improvement product commercials have a mid-level (or normal) priority, and advertisements for beverages have a relatively high-level priority. For example, step 110 may comprise presenting a graphical user interface comprising a list of priorities from which the user may select (or define) respective priorities for presentation of respective advertisements (e.g., for particular products, particular types of products, particular sources of products, particular general styles of advertisements, particular specifically-identified advertisements, etc.).

Note that the exemplary input characteristics discussed above may be input by the user separately, but may also be input by the user in any combination thereof. For example, step 110 may comprise providing a user with a user interface by which the user may aggregate any one or more of the above-mentioned characteristics.

For example, in a non-limiting exemplary scenario, the user may specify that, during a first time window, only family-friendly advertisements concerning toys and healthy foods are to be presented. Such scenario may also comprise the user specifying that during a late-night time window, only humorous advertisements, adult-oriented advertisements and other particular identified advertisements are to be presented. Such scenario may further comprise the user specifying that at all other times, advertisements for automobiles and home appliances are preferred over advertisements for health care products, but that health care products are still allowable.

In general, the user interface provided at step 110 may comprise user interface features by which a user may input (or specify) any of a variety of characteristics of advertising content. Accordingly, the scope of various aspects of the present invention should not be limited by any particular advertising content characteristics and/or by any combination of such characteristics unless explicitly claimed.

The exemplary method 100 may, for example at step 120, comprise selecting advertising based, at least in part, on the input characteristics (e.g., as input at step 110). Such selection of advertising content may comprise any of a variety of characteristics, non-limiting examples of which will now be provided.

For example, as mentioned above, an advertising profile may be created. Such a profile may be for a particular user, for a particular household, for a particular piece of user equipment, etc. An advertising profile may, for example, be created as part of step 110 discussed previously and/or at step 120. As mentioned above, an advertising profile may identify particular types of advertisements to be presented at different times and may also, for example, include information of prioritization associated with respective advertising. Step 120 may comprise selecting advertising based on the above-mentioned advertising profile. Note that in an exemplary scenario in which different users of same user equipment, and in which each user has their own respective profile, step 120 may also comprise determining which profile to use (e.g., based on user input, based on user identification, etc.).

Providers of advertising content may also prioritize advertising content. For example, step 120 may comprise receiving advertisement prioritization information (e.g., in a priority-based ordered list) from one or more providers of such advertising content. For example, a television provider may assign priority levels in accordance with revenue associated with particular advertisers.

In such a scenario, step 120 may comprise identifying the highest priority advertising content (e.g., as prioritized by the content provider) that meets advertisement criteria specified by the user (e.g., at step 110). In such a manner, the user ultimately receives the advertising content desired by the user, advertisers reach the parties that are the most interested in their respective products, and advertising content providers provide their highest priority advertising content that particular users wish to receive. In one exemplary implementation, step 120 may comprise traversing an ordered list of advertising content (e.g., in order from highest priority to lowest priority) provided by a programming provider until an advertisement is identified that matches advertisement criteria specified by the user.

Note that step 120 may also comprise requesting a particular desired advertisement from a provider of such advertising content. In such a scenario, step 120 may comprise determining whether particular desired advertising content is still available to a user, and communicating with a provider of such content to acquire such content if available. As part of such selection process, step 120 may comprise interacting with the user to notify the user when particular advertising content designated as being desirable by the user is no longer available. In such a scenario, the user may then remove such specified content from the profile and/or such specified content may be removed automatically by the system (e.g., without direct interaction with the user). Such operation may, for example, maintain the amount advertising control information to a reasonable level.

Also, as mentioned above, a user may specify time windows during which particular types of advertising are desired (or acceptable). In such a scenario, step 120 may comprise time-shifting received advertising content to a time window specified by the user as being desired (or appropriate) for such advertising content. For example, a received adult-oriented advertisement may be time-shifted by the system for presentation during late evening hours. Similarly, a received child-oriented advertisement may be time-shifted to a time window designated for presentation of such advertising content (e.g., during a time window generally associated with family-oriented or child television programming).

In another exemplary scenario, step 120 may comprise replacing received advertising content that does not conform to user-specified characteristics with advertising that conforms to user-specified characteristics. For example, in an exemplary scenario in which a user has specified that only beverage advertising content, truck advertising content and humorous advertising content is to be presented when football is being played, a received advertisement concerning financial services may be replaced by a humorous advertisement (e.g., of a similar duration). In such a scenario, the financial service advertising content may then be time-shifted to a window that has been defined by the user as being desirable for such advertising content.

In various exemplary scenarios, step 120 may comprise overriding user preference information input by a user regarding advertising content to be presented to the user. For example, in a scenario in which an advertisement has a particularly high priority, step 120 may comprise presenting such advertisement to the user regardless of any user preference information input at step 110. In another exemplary scenario, for example a scenario in which user-defined advertisement criteria are too restrictive to allow effective presentation of advertising content, step 120 may comprise overriding (at least occasionally) the overly restrictive user preferences.

In general, step 120 may comprise selecting advertising based, at least in part, on the input characteristics (e.g., as input at step 110). Accordingly, the scope of various aspects of the present invention should not be limited by characteristics of any particular manner of selecting advertising unless explicitly claimed.

The exemplary method 100 may, for example at step 130, comprise presenting selected advertising content (e.g., as selected at step 120). Step 130 may comprise presenting selected advertising content in any of a variety of manners, non-limiting examples of which will now be provided.

For example, step 130 may comprise presenting selected advertising content on a screen of user equipment implementing the method 100. Also for example, step 130 may comprise outputting a video display driver signal and/or video data that causes (or results in) selected advertising content to be displayed on a video display external to user equipment implementing the method 100 (e.g., outputting such signal(s) to an external television, to a television or media system controller with an on-board display, to a personal computing device or system, etc.).

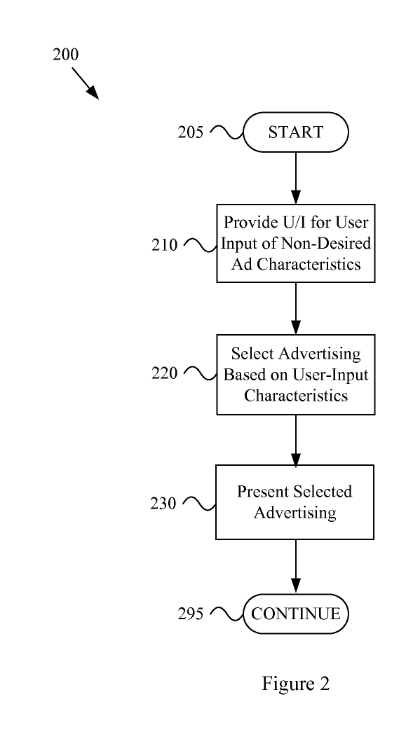

The exemplary method 100 may, at step 195, comprise continuing operation. Such continued operation may comprise any of a variety of characteristics, non-limiting examples of which will now be presented. For example, step 195 may comprise returning execution flow of the exemplary method 100 to any of the previous steps (e.g., for additional acquisition of advertising characteristic information from a user, for additional advertising content selection, etc.). Also for example, step 195 may comprise performing any other operations discussed herein (e.g., with regard to any of the steps of the exemplary method 200 illustrated in FIG. 2 and discussed below).

The previous discussion of the method 100 illustrated in FIG. 1 generally concerned providing a user interface for user input of information regarding advertising characteristics, where such characteristics generally concerned characteristics of desirable (or allowable) advertising content. Such characteristics may also, for example, comprise characteristics of advertising content that is not desired (or allowable). In other words, the characteristics of advertising content may comprise desirable and/or undesirable advertising content characteristics. The following discussion of the method 200 illustrated in FIG. 2 will provide various non-limiting examples of such operation.

FIG. 2 shows a non-limiting exemplary flow diagram of a method 200 for providing user specification of advertising content, in accordance with various aspects of the present invention. The exemplary method 200 may, for example, share any or all characteristics with the exemplary method 100 illustrated in FIG. 1 and discussed previously. Any or all aspects of the exemplary method 200 may, for example, be implemented in user equipment (e.g., a personal video recorder, a television receiver (or set top box) with or without video recording capability, a gaming device, a personal computing device (e.g., handheld, notebook, laptop, desktop, etc.), etc. Also, any or all aspects of the exemplary method 200 may be performed by non-user equipment (e.g., network video content server apparatus, communication network infrastructure apparatus, etc.).

The exemplary method 200 may begin executing at step 205. Step 205 may share any or all characteristics with step 105 of the exemplary method 100 illustrated in FIG. 1 and discussed previously. Also for example, step 205 (or, for example, step 240) may begin executing at step 195 (or any other step) of the exemplary method 100 illustrated in FIG. 1.

The exemplary method 200 may, for example at step 210, comprise providing a user interface by which a user may input characteristics of advertising content. For example, step 210 may comprise providing a user interface by which a user may input characteristics of advertising content that is not desired (or not allowed) by the user. Step 210 may, for example, share any or all characteristics with step 110 of the exemplary method 100 illustrated in FIG. 1 and discussed previously.

In general, as discussed previously with regard to step 110 of FIG. 1, step 210 may comprise providing any of a variety of different general types of user interfaces to the user. Accordingly, the scope of various aspects of the present invention should not be limited by characteristics of a particular general type of user interface unless explicitly claimed.

The user interface provided at step 210 may comprise user interface features by which a user may input (or specify) any of a variety of characteristics of advertising content, non-limiting examples of which will now be provided.

For example, the input characteristics of advertising content may comprise information identifying a specific type of product. For example, step 210 may comprise providing a user (e.g., of user equipment implementing the method 200 or a portion thereof) with a user interface that provides a convenient mechanism by which the user may identify one or more types of products for which the user does not desire to view advertisements.

For example, in an exemplary scenario, a user may have an interest in blocking various advertising content, for example, automobile commercials, consumer electronics commercials, television commercials, telephone commercials, beverage commercials, entertainment event commercials, home improvement product commercials, hair care product commercials, clothing commercials, toy commercials, etc. For example, step 210 may comprise presenting a graphical user interface comprising a list of selectable product types (or general product categories) from which the user may select one or more product types for which the user does not desire advertising content to be presented.

Also for example, the input characteristics of advertising content may comprise information identifying a specific product. For example, step 210 may comprise providing a user (e.g., of user equipment implementing the method 200 or a portion thereof) with a user interface that provides a convenient mechanism by which the user may specify products for which the user does not desire advertising content to be presented.

For example, in an exemplary scenario, a user may have an interest blocking commercials for a particular adult product, a particular alcoholic beverage, an infomercial for a particular cleansing product, a particular vehicle, a particular home care product, a particular health care product, etc. For example, step 210 may comprise presenting a graphical user interface comprising a list (e.g., a multilayer nested list) of selectable products (or general product categories) from which the user may select one or more products for which the user does not desire to view advertising content.

Additionally for example, the input characteristics of advertising content may comprise information identifying a particular provider (or source) of an advertised product. Such a provider may, for example, be a manufacturer and/or distributor of a consumer good, a provider of a consumer service, etc.

For example, in an exemplary scenario, a user may have no interest in products provided by a particular manufacturer, distributer, retailer or provider, the user may have no interest in products produced by manufacturers in a particular geographical region, the user may have no interest in products provided by retailers located outside of a particular distance from the user's home, etc. For example, step 210 may comprise presenting a graphical user interface comprising a list of selectable product providers from which the user may select one or more product sources for which the user does not desire to view advertising content.

Additionally for example, the input characteristics of advertising content may comprise information identifying a general style (or type) of advertising content. Such a general style (or type) may, for example, be independent of a particular product (or product type) being advertised. For example, such a style may comprise characteristics of an advertisement genre.

For example, a user may have no interest in one or more general advertising styles and/or an interest in explicitly blocking particular styles of advertising. For example, a user may specify a desire to not be presented with advertisements of an adult nature, family-oriented advertising, baby-oriented advertising, advertisements of a spiritual nature, advertisements including violence, action-packed advertisements, etc. For example, step 210 may comprise presenting a graphical user interface comprising a list of selectable general advertisement styles from which the user may select one or more styles of advertising that are not to be presented to the user.

Also for example, the input characteristics of advertising content may comprise information identifying a specific advertisement. For example, step 210 may comprise providing a user (e.g., of user equipment implementing the method 200 or a portion thereof) with a user interface that provides a convenient mechanism by which the user may specify a particular advertisement that the user would not like to view again (e.g., a particular advertisement for a product in which the user has no interest, a particular advertisement containing an adult theme that the user wishes to block from future presentation, etc.).

For example, in an exemplary scenario, a user may view an advertisement that the user considers to be offensive, irrelevant to the user, of a general type that is inappropriate for various members of the user's family, etc. In such a scenario, step 210 may comprise presenting a graphical user interface by which the user may identify (or flag) the advertisement for future blocking. For example, step 210 may comprise presenting the user with a selectable list of recently presented advertisements from which the user may select undesirable advertisements.

Also for example, step 210 may comprise providing a button (e.g., a remote control button, a button on a personal portable electronic device, etc.) that when pressed, flags a particular advertisement (e.g., an advertisement currently being presented) as undesirable for future viewing. Such a button may, for example, be temporarily dedicated to such operation, but may also be permanently dedicated to such operation.

In various exemplary scenarios, such specification of a particular advertisement by a user may result in (e.g., at step 120) the selected advertisement(s) being blocked for all future presentation, blocked for a particular time period, etc.

For example, the input characteristics of advertising content may comprise time information associated with advertising content. For example, step 210 may comprise providing a user (e.g., of user equipment implementing the method 200 or a portion thereof) with a user interface that provides a convenient mechanism by which the user may specify a time window associated with presentation of particular advertising content and/or with blocking particular undesirable advertising content. As will be discussed in more detail below, such time window information may be utilized to filter out particular advertising content that the user specifies is not to be presented during such time window and/or to time-shift particular advertising content to a time window during which the user has indicated such advertising content is desirable (or allowable).

For example, in an exemplary scenario, a user may specify a desire for alcoholic beverage commercials to be blocked, except during late evening hours and/or during presentation of football games. A user may similarly, for example, specify that family-oriented commercials and toy commercials are only to be presented during morning and afternoon hours. A user may also, for example, identify a specific commercial (e.g., a commercial being presently provided to the user) for non-presentation during a particular time range. For example, step 210 may comprise presenting a graphical user interface comprising a list of times from which the user may select (or define) respective time constraints for presentation of advertisements (e.g., for particular products, particular types of products, particular sources of products, particular general styles of advertisements, particular specifically-identified advertisements, etc.).

Still further for example, the input characteristics of advertising content may comprise prioritization information associated with advertising content. For example, step 210 may comprise providing a user (e.g., of user equipment implementing the method 200 or a portion thereof) with a user interface that provides a convenient mechanism by which the user may specify priority associated with presentation of particular advertising content. For example, a user may specify a relatively low priority (e.g., lower than normal) for advertising content for products in which the user has relatively little interest. For example, such prioritization may be utilized to provide preferred advertising content to the user while not necessarily eliminating all lower-priority advertisements.

For example, in an exemplary scenario, a user may specify that humorous commercials and automobile commercials have the highest priority. A user may similarly, for example, specify that home improvement product commercials have a mid-level (or normal) priority, and advertisements for toys have a relatively low-level priority. For example, step 210 may comprise presenting a graphical user interface comprising a list of priorities from which the user may select (or define) respective priorities for presentation of respective advertisements (e.g., for particular products, particular types of products, particular sources of products, particular general styles of advertisements, particular specifically-identified advertisements, etc.).

Note that the exemplary input characteristics discussed above may be input by the user separately, but may also be input by the user in any combination thereof. For example, step 210 may comprise providing a user with a user interface by which the user may aggregate any one or more of the above-mentioned characteristics (e.g., including characteristics of desirable advertising content as discussed previously with regard to step 110 of the method 100 shown in FIG. 1).

For example, in a non-limiting exemplary scenario, the user may specify that, during a first time window, only family-friendly advertisements concerning toys and healthy foods are to be presented. Such scenario may also comprise the user specifying that during a late-night time window, only adult-oriented advertisements and other particularly identified advertisements are to be presented. Such scenario may further comprise the user specifying that at all other times, advertisements for automobiles and home appliances are preferred over advertisements for health care products, but that health care products are still allowable.

In general, the user interface provided at step 210 may comprise user interface features by which a user may input (or specify) any of a variety of characteristics of advertising content. Accordingly, the scope of various aspects of the present invention should not be limited by any particular advertisement characteristics and/or by any combination of such characteristics unless explicitly claimed.

The exemplary method 200 may, for example at step 220, comprise selecting advertising based, at least in part, on the input characteristics (e.g., as input at step 210). Such selection of advertising content may comprise any of a variety of characteristics, non-limiting examples of which will now be provided.

For example, as mentioned above, an advertising profile may be created. Such a profile may be for a particular user, for a particular household, for a particular piece of user equipment, etc. An advertising profile may, for example, be created as part of step 210 discussed previously and/or at step 220. As mentioned above, an advertising profile may identify particular types of advertisements that are not to be presented and/or to be presented at particular times and may also, for example, include information of prioritization associated with respective advertising. Step 220 may comprise selecting advertising based on the above-mentioned advertising profile.

Providers of advertising content may also prioritize advertising content. For example, step 220 may comprise receiving advertisement prioritization information (e.g., in a priority-based ordered list) from one or more providers of such advertising content. For example, a television provider may assign priority levels in accordance with revenue associated with particular advertisers.

In such a scenario, step 220 may comprise identifying the highest priority advertising content that does not comprise characteristics specified by the user as undesirable (e.g., at step 210). In such a manner, the user does not receive advertising content having characteristics specified as undesirable by the user, and advertisers do not provide advertising content to parties that do not desire such advertising content. In one exemplary implementation, step 220 may comprise traversing an ordered list of advertising content (e.g., in order from highest priority to lowest priority) provided by a programming provider until an advertisement is identified that does not match advertisement criteria specified by the user as undesirable.

Note that step 220 may also comprise notifying a provider of advertising content that particular types of advertising content are not desired for the particular user. In such a scenario, step 220 may comprise determining whether alternative advertising content is available to a user, and communicating with a provider of such advertising content to acquire such alternative content if available. Such alternative advertising content may, for example, be associated with a same product but be of a generally different type of advertisement (e.g., a different genre).

Also, as part of the selection process, step 220 may comprise interacting with advertising content providers to identify the advertising content that is available. As part of such selection process, step 220 may comprise interacting with the user to notify the user when particular advertising content designated as being undesirable by the user is no longer available. In such a scenario, the user may then remove such specified content from the profile and/or such specified content may be removed automatically by the system (e.g., without direct interaction with the user).

Also, as mentioned above, a user may specify time windows during which particular types of advertising are not desired (or unacceptable). In such a scenario, for received advertising content that has been indicated to be undesirable by the user during the present time window, step 220 may comprise time-shifting such advertising content to a time window specified by the user as being desired (or appropriate) for such advertising content. For example, a received adult-oriented advertisement may be blocked for the present time window and time-shifted by the system for presentation during a later time window. Similarly, a received child-oriented advertisement may be time-shifted to a time window designated for presentation of such advertising content (e.g., during a time window generally associated with family-oriented or child television programming).

In another exemplary scenario, step 220 may comprise replacing received advertising content that does not conform to user-specified characteristics with advertising that conforms to user-specified characteristics. For example, in an exemplary scenario in which a user has specified that adult-oriented commercials are not to be presented in the afternoon, such advertising content may be replaced by family-friendly advertising content (e.g., of a similar duration). In such a scenario, the adult-oriented advertising content may then be time-shifted to a window that has been defined by the user as being desirable for such advertising content.

In various exemplary scenarios, step 220 may comprise overriding user preference information input by a user regarding advertising content that is not to be presented to the user. For example, in a scenario in which an advertisement has a particularly high priority, step 220 may comprise presenting such advertisement to the user regardless of any user preference information input at step 210. In another exemplary scenario, for example a scenario in which user-defined advertisement criteria are too restrictive to allow effective presentation of advertising content, step 220 may comprise overriding (at least occasionally) the overly restrictive user preferences.

In general, step 220 may comprise selecting advertising based, at least in part, on the input characteristics (e.g., as input at step 210). Accordingly, the scope of various aspects of the present invention should not be limited by characteristics of any particular manner of selecting advertising unless explicitly claimed.

The exemplary method 200 may, for example at step 230, comprise presenting selected advertising content (e.g., as selected at step 220). Step 230 may, for example, share any or all characteristics with step 130 of the exemplary method 100 illustrated in FIG. 1 and discussed previously.

The exemplary method 200 may, at step 295, comprise continuing operation. Such continued operation may comprise any of a variety of characteristics, non-limiting examples of which will now be presented. For example, step 295 may comprise returning execution flow of the exemplary method 200 to any of the previous steps (e.g., for additional acquisition of advertising characteristic information from a user, for additional advertising content selection, etc.). Also for example, step 295 may comprise performing any other operations discussed herein (e.g., with regard to any of the steps of the exemplary method 100 illustrated in FIG. 1 and discussed below).

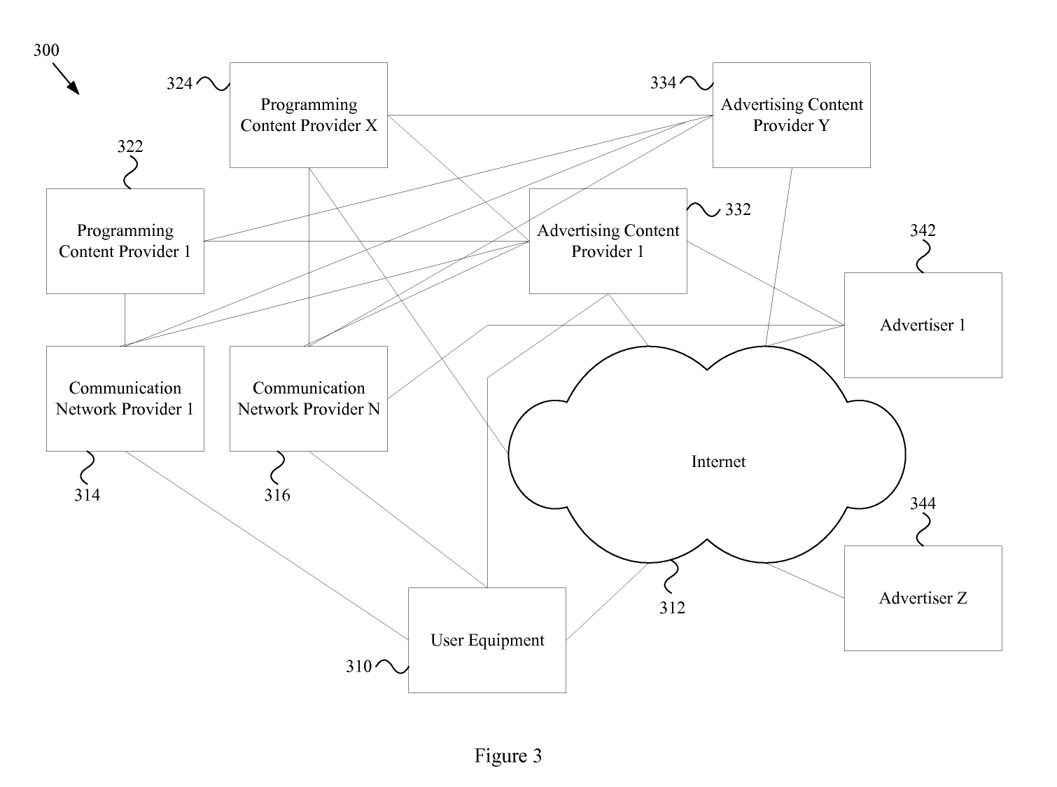

The previous discussions of FIGS. 1 and 2 included discussion of user equipment (e.g., a personal electronic device) performing various aspects of the present invention. The previous discussion also mentioned that various aspects of the present invention may also be implemented in network content source and/or communication network infrastructure apparatus. Such previous discussion also included general discussion of video content (e.g., programming and/or advertising content) sources. FIG. 3 is provided herein to show a non-limiting example of a video content system including user equipment, content providers, and communication networks communicatively coupling such entities. Such illustrative video content system is merely illustrative and non-limiting.

FIG. 3 is a diagram illustrating a video content (e.g., programming and/or advertising video content) distribution environment 300. The exemplary environment 300 comprises user equipment 310 (e.g., an end-user electronic device with video content playing capability).

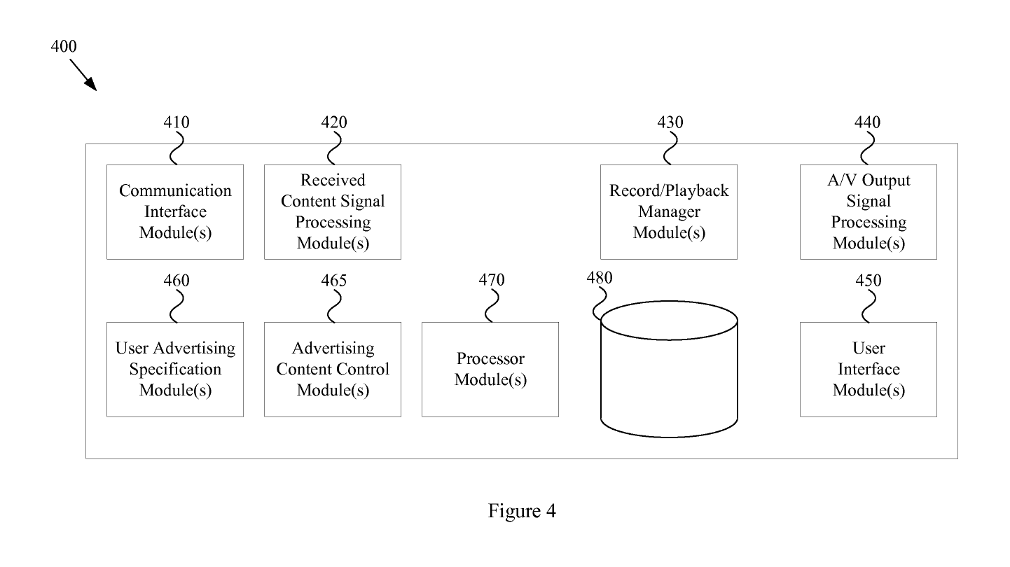

Such user equipment 310 may share any or all characteristics with the user equipment discussed elsewhere herein, including without limitation the user equipment 400 illustrated in FIG. 4. The user equipment 310 may, for example, perform any or all of the functionality discussed previously with regard to the methods 100 and 200 illustrated in FIGS. 1-2 and discussed previously.

The exemplary environment 300 also comprises a plurality of communication networks (or communication network providers). For example, the user equipment 310 is communicatively coupled to a first communication network provider 314 and an N^{th} communication network provider 316. Such communication network providers (314 and 316) may operate to communicatively couple the user equipment 310 to any of a variety of different types of communication networks. For example, such communication network providers (314 and 316) may operate to provide the user equipment 310 access to cable and/or satellite television networks, wired and/or wireless telecommunication networks, wired and/or wireless data networks, wireless networks of various ranges (e.g., PANs, LANs, WANs, MANs, etc.), etc.

The exemplary environment 300 also comprises the Internet 312 (or Internet Service Provider). For example, the user equipment 310 may be communicatively coupled directly to the Internet 312 or via an Internet Service Provider. Note that the user equipment 310 may also, for example, be communicatively coupled to the Internet 312 via the first communication network provider 314 and/or N^{th} communication network provider 316.

The exemplary environment 300 also comprises a plurality of programming content providers (e.g., 1 to X programming providers). For example, the illustrated environment 300 shows a first programming content provider 322 and an X^{th} programming content provider 324. Such programming content providers (322 and 324) may operate to provide programming content (or any video content) to the user equipment 310 via any of the communication networks (or providers) discussed above. A programming provider may, for example, include a television programming provider, a computer network programming provider, a television network or portion thereof (e.g., Fox, NBC, CBS, ABC, ESPN, NFL, HGTV, etc.), etc.

In an exemplary scenario, the first programming content provider 314 may operate to communicate a first television program to the user equipment 310 via the first communication network provider 314. Such a first television program may, for example, comprise embedded first advertising video content that the first programming content provider 314 received from the first advertising content provider 332 and embedded into the first program.

In another exemplary scenario, the X^{th} programming content provider 314 may operate to communicate a second television program to the user equipment 310 via the N^{th} communication network provider 316 and/or via the Internet 312. Such second television program may, for example, alternatively contain no advertising content or contain advertising content received from any or all of the advertising content providers (332 or 334) or advertisers (342 or 344) in the environment 300 or external to the illustrated environment 300.

As mentioned previously, the user equipment 310 may interact with video content providers (e.g., programming content providers, advertising content providers, advertisers, communication service providers, etc.) to, at least in part, determine whether particular advertising content is available, to acquire advertising content, etc. In such an exemplary scenario, the user equipment 310 operates to communicate with any or all of the communication network providers (314 and 316), the programming content providers (322 and 324), the advertising content providers (332 and 334), and the advertisers (342 and 344).

As mentioned above, advertising video content may be embedded in programming video content. Also for example, as illustrated by various communication pathways in the environment 300, the user equipment 310 may operate to receive advertising content directly from the advertising content providers or advertisers (e.g., advertising enterprises).

As referred to above, the exemplary environment 300 also, for example, comprises a plurality of advertising content providers (e.g., 1 to Y advertising content providers). For example, the illustrated environment 300 shows a first advertising content provider 332 and a Y^{th} advertising content provider 334. Such advertising content providers (332 and 334) may operate to provide advertising video content to the user equipment 310 via any of the communication networks (or providers) discussed above. Also for example, such advertising providers (332 and 334) may operate to provide advertising video content to the programming content providers (322 and 324) for ultimate communication to the user equipment 310 (e.g., embedded in a television program, communicated in a data stream independent of data streams communicating television programming, etc.).

Also, as mentioned above, the exemplary environment 300 also comprises a plurality of advertisers (e.g., 1 to Z advertisers). For example, the illustrated environment 300 shows a first advertiser 342 (e.g., a first commercial enterprise advertising a product or service provided by such first commercial enterprise) and a Z^{th} advertiser 344 (e.g., a Z^{th} commercial enterprise advertising a product or service provided by such Z^{th} commercial enterprise). As illustrated in FIG. 3, such advertisers (342 and 344) may operate to communicate advertising content (or related information) to enterprises that specialize in generating video advertising content (e.g., advertising content providers 332 and 334), communicate advertising content (or related information) to programming content providers (e.g., the programming content providers 322 and 324), communicate advertising content (or related information) to communication network providers (or networks) (e.g., the communication network providers 314 and 316, the Internet 312 (or ISP), etc.), and/or communicate advertising content (or related information) directly to the user equipment 310).

In general, the exemplary environment 300 provides a non-limiting illustration of various entities that might or might not be present in any particular video content distribution system. Accordingly, the scope of various aspects of the present invention should not be limited by characteristics of the exemplary environment 300 unless explicitly claimed.

FIG. 4 is a diagram illustrating various non-limiting aspects of exemplary user equipment 400. The user equipment may comprise characteristics of any of a variety of types of user equipment. For example and without limitation, the user equipment 400 may be or comprise an electronic device with video processing capability. For example, the user equipment 400 may comprise a personal video recorder, a television receiver (or set top box, for example cable and/or satellite), a gaming device, a television, a personal computing device (e.g., handheld, notebook, laptop, desktop, etc.), a distributed home network comprising communicatively coupled devices that operate to play video content, etc. Such user equipment 400 may, for example, be integrated into a single housing or a plurality of housings of a personal audio/video entertainment system. Such user equipment may also, for example, comprise video recording capability (e.g., advertising content recording capability) for time-shifting video content. In a configuration comprising a plurality of housings, such user equipment may be co-located or positioned at geographically distinct locations.

The user equipment 400 may, for example, share any or all characteristics with the user equipment 310 of the environment 300 illustrated in FIG. 3 and discussed previously. Also for example, the user equipment 400 (e.g., one or more modules thereof) may, for example, operate to perform any or all functionality discussed previously with regard to the methods 100 and 200 illustrated in FIGS. 1-2 and discussed previously.

The user equipment 400 may, for example, comprise one or more communication interface modules 410 that operate to perform any or all of the communication interface functionality discussed herein. The communication interface module(s) 410 may, for example, operate to communicate over any of a variety of communication media and utilizing any of a variety of communication protocols (e.g., including operating in accordance with various respective protocol layers, for example, PHY, MAC, network, transport, etc.). For example, the communication interface module 410 may be operable to communicate via one or more wired and/or wireless communication ports. The communication interface module(s) 410 may, for example, operate to communicate with one or more communication networks (e.g., cable television networks, satellite television networks, telecommunication networks, the Internet, local area networks, personal area networks, metropolitan area networks, etc.) via which video content (e.g., television program content, advertising video content, etc.) and/or other data (e.g., information regarding advertising video content desired or not desired by a user, user information, account information, general data, etc.) is communicated. Also for example, the communication interface module(s) 410 may operate to communicate with local sources of video content (e.g., video recorders, receivers, gaming devices, etc.) that may, for example, be external to but communicatively coupled to the user equipment 400. Additionally, for example, the communication interface module(s) 410 may operate to communicate with a controller for the user equipment (e.g., directly or via one or more intermediate communication networks).

The exemplary user equipment 400 may also comprise additional communication interface modules, which are not illustrated. Such additional communication interface modules may, for example, share any or all aspects with the communication interface module(s) 410 discussed above.

The exemplary user equipment 400 may comprise one or more signal processing modules 420. Such signal processing module(s) 420 may, for example, operate to process received video and/or data content (e.g., programming and/or advertising content, user interface content received via a communication network etc.). Such signal processing modules may, for example and without limitation, comprise video decoding modules, transcoding modules that convert coded content from one code to another, audio processing modules, etc.

The exemplary user equipment 400 may comprise one or more video record/playback manager modules 430. Such module(s) 430 may operate to manage the recording and playback of video content (e.g., program content, advertising content, etc.). Such module(s) 430 may operate to perform any or all of the video recording and/or playback functionality discussed herein.

Such module(s) 430 may, for example, operate to utilize the user interface module(s) 450 to interact with a user regarding desired recording and playback operation. Such module(s) may, for example, operate to interact with the memory 480 (or with an external memory) for recording video content and/or reading recorded video content. Such module(s) 430 may, for example, operate to interact with the advertising content control module(s) 465 which selects advertising content to be presented with program content. Such module(s) 430 may also, for example, operate to utilize the A/V output signal processing module(s) 440 to process output video content for ultimate presentation to a user.

As mentioned above, the exemplary user equipment 400 may also comprise one or more audio/video output signal processing modules 440. Such A/V output processing module(s) 440 may, for example, operate to process audio and/or video information for output to a display and/or speaker device. For example, such A/V output processing module(s) 440 may operate to receive stored video content (e.g., stored programming and/or advertising content) information from the memory 480 and process such information (e.g., performing decoding, performing decompressing, converting video data into video display driver signals, etc.) for output to a user. For example, the A/V output processing module(s) 440 may operate to output audio speaker and/or video display driver signals. Also for example, the A/V output processing module(s) 440 may operate to output processed audio and/or video data for further downstream processing (e.g., for ultimate presentation to a user in human-perceivable form).

The exemplary user equipment 400 may also comprise one or more user interface modules 450. The user interface module(s) 450 may generally operate to provide user interface functionality to a user of the user equipment 400. The user interface module(s) 450 may, for example, operate to perform any or all of the user interface functionality discussed herein.

For example, and without limitation, the user interface module(s) 450 may operate to provide for user control of any or all standard user equipment commands (e.g., video recording and/or playback control, for example, record commands, playback commands scheduled recording commands, channel control, on/off control, video input and/or output selection, programming interaction, interacting with the user regarding the presentation of advertising video content before, during and/or after the presentation of the recorded program video content, etc.).

The user interface module(s) 450 may, for example, operate to respond to user commands utilizing user interface features disposed on the user equipment 400 (e.g., buttons, etc.) and may also utilize the communication module(s) 410 to communicate with a controller (e.g., a dedicated user equipment remote control, a universal remote control, a cellular telephone, personal computing device, gaming controller, etc.). Further for example, the user interface module(s) 450 may utilize the communication module(s) 410 to communicate with another device external to the user equipment 400 to utilize the user interface features of such external device.

The exemplary user equipment 400 may comprise one or more processors 470. The processor(s) 470 may, for example, comprise a general purpose processor, digital signal processor, application-specific processor, microcontroller, microprocessor, etc. For example, the processor(s) 470 may operate in accordance with software (or firmware) instructions. As mentioned previously, in addition to or in lieu of any or all functionality discussed herein being performed by discrete hardware (e.g., in distinct separate integrated circuits or combined into a single integrated circuit), any or all functionality discussed herein may be performed by a processor executing instructions. For example, though various modules are illustrated as separate blocks or modules in FIG. 4, such illustrative modules, or any portion thereof, may be implemented by the processor(s) 470.

The exemplary user equipment 400 may comprise one or more memories 480. As discussed above, any or all functional aspects discussed herein may be performed by one or more processors executing instructions. Such instructions may, for example, be stored in the one or more memories 480. Such memory 480 may, for example, comprise characteristics of any of a variety of types of memory. For example and without limitation, such memory 480 may comprise one or more memory chips (e.g., ROM, RAM, EPROM, EEPROM, flash memory, one-time-programmable OTP memory, etc.), hard drive memory, CD memory, DVD memory, etc.

Additionally, as discussed previously, the record/playback manager module(s) 430 may interact with the memory 480 to store video content in the memory 480 and/or retrieve stored video content from the memory 480. In such a scenario, the memory 480 may comprise separate memories or may be partitioned to accommodate stored video content and processor instructions, along with user data and any other type of data (e.g., advertising content profile information, user profile information, user account information, scratch pad data, etc.).

The exemplary user equipment 400 may also comprise one or more advertising specification modules 460. Such advertising specification module(s) 460 may, for example, operate to perform any or all of the advertising specification functionality discussed herein. For example and without limitation, the advertising specification module(s) 460 may operate to perform any or all functionality with regard to step 110 of the exemplary method 100 illustrated in FIG. 1 and discussed previously and/or any or all functionality with regard to step 210 of the exemplary method 200 illustrated in FIG. 2 and discussed previously. For example, the module(s) 460 may operate to interact with a user (e.g., utilizing the user interface module(s) 450) to provide a user interface by which a user may input characteristics of advertising content. Various non-limiting examples of such operation will now be presented.

Such user interface may, for example, comprise any of a variety of user interface characteristics, non-limiting examples of which will now be provided. For example, the user interface may comprise characteristics of a graphical user interface. Such a graphical user interface may, for example, be provided on a television screen of a user home media system (e.g., a screen of the user equipment 400, a television screen communicatively coupled to the user equipment 400, a screen of a remote control device communicatively coupled to the user equipment 400, etc.). Such a graphical user interface may, for example, be provided on a screen of a personal electronic device (e.g., a personal computing device, a cellular telephone, a personal digital assistant, a notebook computer, a laptop or desktop computer system, etc.). In such scenarios, the user may then interact with the graphical user interface in a manner corresponding to the respective type of graphical user interface provided to the user (e.g., utilizing a keypad, utilizing a touch screen, utilizing a cursor moving mechanism, etc.). Such a graphical user interface may, for example, comprise characteristics of a menu-based system, in which a user may select (e.g., from a predetermined list) advertising characteristics, time characteristics, etc.).

Also for example, such user interface may comprise characteristics of one or more dedicated buttons (e.g., on a media controller). For example, a button may (e.g., temporarily and/or permanently) be assigned to functionality related to user-specification of advertising characteristics. For example, as will be discussed below, a user may flag a particular advertisement as desirable (e.g., for repeated viewing) or as undesirable (e.g., for future blocking). Such flagging may, for example, be performed by pressing a single button (e.g., during play of the advertisement) on a controller, by selecting an icon overlaid on the advertisement while the advertisement is presented, etc.).

In general, the advertising specification module(s) 460 may operate to provide (e.g., utilizing the user interface module(s) 450) any of a variety of different general types of user interfaces to the user. Accordingly, the scope of various aspects of the present invention should not be limited by characteristics of a particular general type of user interface unless explicitly claimed.

The user interface provided by the advertising specification module(s) 460 may comprise user interface features by which a user may input (or specify) any of a variety of characteristics of advertising content, non-limiting examples of which will now be provided, and many non-limiting examples of which were presented previously (e.g., in the discussions of the exemplary method 100 of FIG. 1 and the exemplary method 200 of FIG. 2).

For example, the input characteristics of advertising content may comprise information identifying a specific type of product. Also for example, the input characteristics of advertising content may comprise information identifying a specific product. Additionally for example, the input characteristics of advertising content may comprise information identifying a particular provider (or source) of an advertised product. Further for example, the input characteristics of advertising content may comprise information identifying a general style (or type) of advertising content.

Also for example, the input characteristics of advertising content may comprise information identifying a specific advertisement. For example, in an exemplary scenario, a user may view an advertisement that the user considers to be interesting, entertaining, humorous, immediately relevant to the user, of a general type that is of interest (or not of interest) to the user, etc. In such a scenario, the advertising specification module(s) 460 may operate to present a graphical user interface by which the user may identify (or flag) the advertisement for future viewing (or blocking). For example, the advertising specification module(s) 460 may operate to present the user with a selectable list of recently presented advertisements from which the user may select a desired advertisement. Also for example, the advertising specification module(s) 460 may operate to provide a button (e.g., a remote control button, a button on a personal portable electronic device, a button on the user equipment 400, etc.) that when pressed, flags a particular advertisement (e.g., an advertisement currently being presented) as desirable (or undesirable) for future viewing. Such a button may, for example, be temporarily dedicated to such operation, but may also be permanently dedicated to such operation.

Still further for example, the input characteristics of advertising content may comprise time information associated with advertising content. Also for example, the input characteristics of advertising content may comprise prioritization information associated with advertising content.

Note that the exemplary input characteristics discussed above may be input by the user separately, but may also be input by the user in any combination thereof. For example, the advertising specification module(s) 460 may operate to provide a user with a user interface by which the user may aggregate any one or more of the above-mentioned characteristics.

In general, the user interface provided by the advertising specification module(s) 460 (e.g., utilizing the user interface module(s) 450) may comprise user interface features by which a user may input (or specify) any of a variety of characteristics of advertising content. Accordingly, the scope of various aspects of the present invention should not be limited by any particular advertisement characteristics and/or by any combination of such characteristics unless explicitly claimed.

The exemplary user equipment 400 may also comprise one or more advertising content control modules 465. Such advertising content control module(s) 465 may, for example, operate to perform any or all of the advertising content control functionality discussed herein.

For example and without limitation, the advertising content control module(s) 465 may operate to perform any or all functionality with regard to steps 120 and 130 of the exemplary method 100 illustrated in FIG. 1 and discussed previously and/or any or all functionality with regard to steps 220 and 230 of the exemplary method 200 illustrated in FIG. 2 and discussed previously.

For example and without limitation, the advertising content control module(s) 465 may operate to select advertising based, at least in part, on user-input advertising characteristics (e.g., as obtained by the user advertising specification module(s) 460). Such selection of advertising content may comprise any of a variety of characteristics, non-limiting examples of which will now be provided.

For example, as mentioned above, an advertising profile may be created. Such a profile may be for a particular user, for a particular household, for a particular piece of user equipment, etc. An advertising profile may, for example, be created by the user advertising specification module(s) 460 and/or by the advertising content control module(s) 465. Such advertising profile may then, for example be stored on-board the user equipment 400 in the local memory 480 and/or in a remote memory via the communication interface module(s) 410 (e.g., in a memory of another user device and/or in a networked memory remote from the user equipment 400). As mentioned above, an advertising profile may identify particular types of advertisements to be presented at different times and may also, for example, include information of prioritization associated with respective advertising. The advertising content control module(s) 465 may, for example, operate to select advertising based on the above-mentioned advertising profile.

Providers of advertising content may also prioritize advertising content. For example, the advertising content control module(s) 465 may operate to receive advertisement prioritization information (e.g., in a priority-based ordered list) from one or more providers of such advertising content (e.g., via the communication interface module(s) 410). For example, a television provider may assign priority levels in accordance with revenue associated with particular advertisers.

In such a scenario, the advertising content control module(s) 465 may operate to identify the highest priority advertising content that meets advertisement criteria specified by the user (e.g., via the user advertising specification module(s) 460) as being desirable (and/or does not match advertisement criteria specified by the user as being undesirable). In such a manner, the user ultimately receives the advertising content desired by the user, advertisers reach the parties that are the most interested in their respective products, and advertising content providers provide their highest priority advertising content that particular users wish to receive. In one exemplary implementation, the advertising content control module(s) 465 may operate to traverse an ordered list of advertising content (e.g., in order from highest priority to lowest priority) provided by a programming provider until an advertisement is identified that matches advertisement criteria specified by the user.

Note that the advertising content control module(s) 465 may also operate to request a particular desired advertisement from a provider of such advertising content (e.g., via the communication interface module(s) 410). In such a scenario, the advertising content control module(s) 465 may operate to determine whether particular desired advertising content is still available to a user, and communicate with a provider of such content to acquire such content if available. As part of such selection process, the advertising content control module(s) 465 may operate to interact with the user (e.g., via the user interface module(s)) to notify the user when particular advertising content designated as being desirable (or undesirable) by the user is no longer available. In such a scenario, the user may then remove such specified content from the profile and/or such specified content may be removed automatically by the user equipment 400 (e.g., without direct interaction with the user). Such operation may, for example, maintain the amount advertising control information to a reasonable level.

Also, as mentioned above, a user may specify time windows during which particular types of advertising are desired (or acceptable). In such a scenario, the advertising content control module(s) 465 may operate to time-shift received advertising content to a time window specified by the user as being desired (or appropriate) for such advertising content. For example, a received adult-oriented advertisement may be time-shifted by the user equipment 400 for presentation during late evening hours. Similarly, a received child-oriented advertisement may be time-shifted to a time window designated for presentation of such advertising content (e.g., during a time window generally associated with family-oriented or child television programming). Such time-shifted advertising content may, for example, be stored in the memory 480. Note that any or all of the advertising content being controlled by the advertising content control module(s) 465 may be stored locally in the user equipment 400 (e.g., in the memory 480), in another user device communicatively coupled to the user equipment 400, and/or in a networked video content server remote form the user equipment 400).

In another exemplary scenario, the advertising content control module(s) 465 may operate to replace received advertising content that does not conform to user-specified characteristics with advertising that conforms to user-specified characteristics. For example, in an exemplary scenario in which a user has specified that only beverage advertising content, truck advertising content and humorous advertising content is to be presented when football is being played, a received advertisement concerning financial services may be replaced by a humorous advertisement (e.g., of a similar duration). In such a scenario, the financial service advertising content may then be time-shifted to a window that has been defined by the user as being desirable for such advertising content.

In various exemplary scenarios, the advertising content control module(s) 465 may operate to override user preference information input by a user regarding advertising content to be presented to the user. For example, in a scenario in which an advertisement has a particularly high priority, the advertising content control module(s) 465 may operate to present such advertisement to the user regardless of any user preference information input via the user advertising specification module(s) 460. In another exemplary scenario, for example a scenario in which user-defined advertisement criteria are too restrictive to allow effective presentation of advertising content, the advertising content control module(s) 465 may operate to override (at least occasionally) the overly restrictive user preferences.

In general, the advertising content control module(s) 465 may operate to select advertising based, at least in part, on the input characteristics (e.g., as input via the user advertising specification module(s) 460). Accordingly, the scope of various aspects of the present invention should not be limited by characteristics of any particular manner of selecting advertising unless explicitly claimed.

The advertising content control module(s) 465 may also operate to present (or manage presentation of) selected advertising content (e.g., as selected by the advertising content control module(s) 465). The advertising content control module(s) 465 may operate to present (or manage presentation of) selected advertising content in any of a variety of manners, non-limiting examples of which will now be provided.

For example, the advertising content control module(s) 465 may operate to present selected advertising content on a screen of the user equipment 400 (e.g., utilizing the record/playback manager module(s) 430 and/or the user interface module(s) 450). Also for example, the advertising content control module(s) 465 may operate to output a video display driver signal and/or video data (e.g., via the A/V output signal processing module(s) 440 and/or communication interface module(s) 410) that causes (or results in) selected advertising content to be displayed on a video display external to user equipment 400 (e.g., outputting such signal(s) to an external television, to a television or media system controller with an on-board display, to a personal computing device or system, etc.).

Various modules of the user equipment 400 (e.g., the processor module(s) 470) may also operate to perform continued operation. For example, the user equipment 400 may operate to perform any or all functionality discussed previously with regard to step 195 of the exemplary method 100 illustrated in FIG. 1 and discussed previously and discussed with regard to step 295 of the exemplary method 200 illustrated in FIG. 2 and discussed previously.

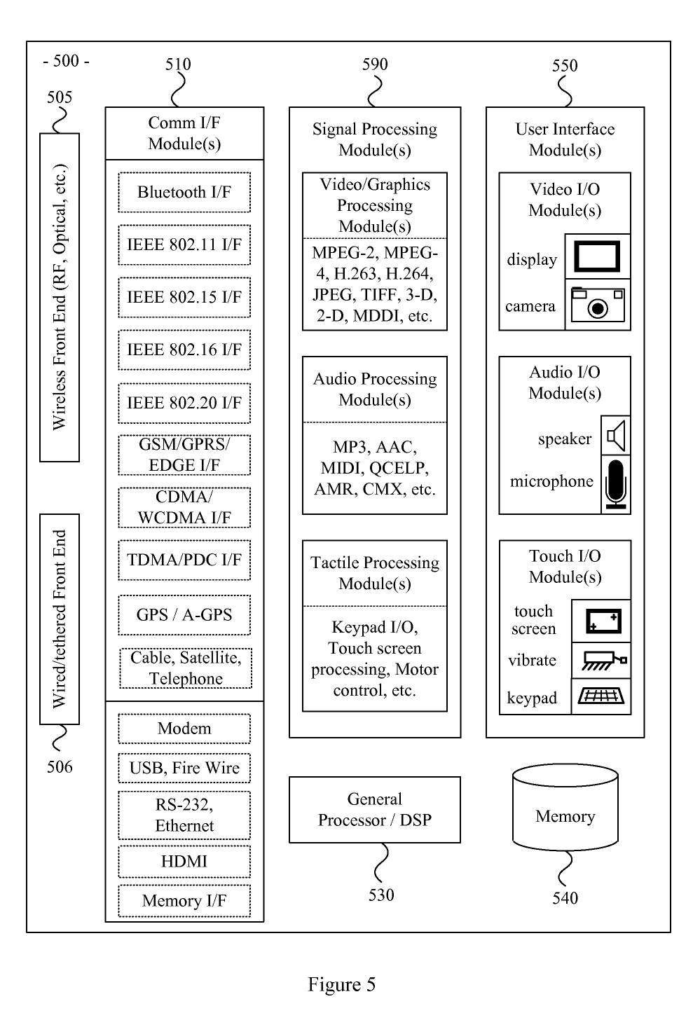

Turning next to FIG. 5, such figure is a diagram illustrating exemplary modules and/or sub-modules for user equipment 500, in accordance with various aspects of the present invention. The exemplary user equipment 500 may share any or all aspects with any of the user equipment 310 and 400 discussed herein and illustrated in FIGS. 3 and 4. For example, the exemplary user equipment 500 (or various modules thereof) may operate to perform any or all functionality discussed herein with regard to the exemplary method 100 illustrated in FIG. 1 and/or the exemplary method 200 illustrated in FIG. 2.

As with the exemplary user equipment 400, the components of the exemplary user equipment 500 may be disposed in a single user device (e.g., a personal video recorder, a television receiver, a gaming device, a personal computing device, etc.). Also, as with the exemplary user equipment 400, various alternative embodiments may comprise the various modules, or a portion thereof, being disposed in other system entities (e.g., in network infrastructure and/or content provider equipment).

For example, the user equipment 500 comprises a processor 530. Such a processor 530 may, for example, share any or all characteristics with the processor(s) 470 discussed with regard to FIG. 4. Also for example, the user equipment 500 comprises a memory 540. Such memory 540 may, for example, share any or all characteristics with the memory 480 discussed with regard to FIG. 4.

Also for example, the user equipment 500 may comprise any of a variety of user interface module(s) 550. Such user interface module(s) 550 may, for example, share any or all characteristics with the user interface module(s) 450 discussed previously with regard to FIG. 4. For example and without limitation, the user interface module(s) 550 may comprise: a display device, a camera (for still or moving picture acquisition), a speaker, an earphone (e.g., wired or wireless), a microphone, a video screen (e.g., a touch screen), a vibrating mechanism, a keypad, and/or any of a variety of other user interface devices (e.g., a mouse, a trackball, a touch pad, touch screen, light pen, game controlling device, etc.).

The exemplary user equipment 500 may also, for example, comprise any of a variety of communication modules (505, 506, and 510). Such communication module(s) may, for example, share any or all characteristics with the communication interface module(s) 410 discussed previously with regard to FIG. 4. For example and without limitation, the communication interface module(s) 510 may comprise: a Bluetooth interface module; an IEEE 802.11, 802.15, 802.16 and/or 802.20 module; any of a variety of cellular telecommunication interface modules (e.g., GSM/GPRS/EDGE, CDMA/CDMA2000/1x-EV-DO, WCDMA/HSDPA/HSUPA, TDMA/PDC, WiMAX, etc.); any of a variety of position-related communication interface modules (e.g., GPS, A-GPS, etc.); any of a variety of wired/tethered communication interface modules (e.g., USB, Fire Wire, RS-232, HDMI, Ethernet, wire line and/or cable modem, etc.); any of a variety of communication interface modules related to communicating with external memory devices; etc. The exemplary user equipment 500 is also illustrated as comprising various wired 506 and/or wireless 505 front-end modules that may, for example, be included in the communication interface modules and/or utilized thereby.

The exemplary user equipment 500 may also comprise any of a variety of signal processing module(s) 590. Such signal processing module(s) 590 may share any or all characteristics with modules of the exemplary user equipment 400 that perform signal processing. Such signal processing module(s) 590 may, for example, be utilized to assist in processing various types of information discussed previously (e.g., with regard to sensor processing, position determination, video processing, image processing, audio processing, general user interface information data processing, etc.). For example and without limitation, the signal processing module(s) 590 may comprise: video/graphics processing modules (e.g. MPEG-2, MPEG-4, H.263, H.264, JPEG, TIFF, 3-D, 2-D, MDDI, etc.); audio processing modules (e.g., MP3, AAC, MIDI, QCELP, AMR, CMX, etc.); and/or tactile processing modules (e.g., keypad I/O, touch screen processing, motor control, etc.).

In summary, various aspects of the present invention provide a system and method for providing user specification of advertising content. While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for providing user-specification of advertising content, the method comprising:
providing a user interface by which a user may input characteristics of advertising content;
selecting advertising based, at least in part, on the input characteristics; and
presenting the selected advertising.

2. The method of claim 1, wherein said providing, said selecting, and said presenting are performed by user equipment.

3. The method of claim 1, wherein said providing a user interface comprises providing a user interface by which a user may input characteristics of advertising content desired by the user.

4. The method of claim 1, wherein said providing a user interface comprises providing a user interface by which a user may input characteristics of advertising content that is not desired by the user.

5. The method of claim 1, wherein said input characteristics of advertising content comprise information identifying a specific product.

6. The method of claim 1, wherein said input characteristics of advertising content comprise information identifying a type of product.

7. The method of claim 1, wherein said input characteristics of advertising content comprise information identifying a particular product source.

8. The method of claim 1, wherein said input characteristics of advertising content comprise information identifying a style of advertising content.

9. The method of claim 1, wherein said input characteristics of advertising content comprise information identifying a particular advertisement.

10. The method of claim 9, wherein said providing a user interface comprises providing a user interface by which a user may flag advertising content that is presently being presented.

11. The method of claim 1, wherein said providing a user interface comprises providing a user interface by which a user may specify a time window associated with advertising content.

12. The method of claim 11, comprising time-shifting advertising content based, at least in part, on the user-specified time window.

13. The method of claim 1, comprising prioritizing advertising content based, at least in part, on the input characteristics.

14. The method of claim 1, wherein said selecting advertising comprises replacing received advertising content that does not conform to user-specified characteristics with advertising that conforms to user-specified characteristics.

15. The method of claim 1, wherein said selecting comprises overriding user-defined advertising content restrictions.

16. A system for providing user-specification of advertising content, the system comprising:
at least one module operable to, at least:
provide a user interface by which a user may input characteristics of advertising content;
select advertising based, at least in part, on the input characteristics; and
present the selected advertising.

17. The system of claim 16, wherein said system is user equipment.

18. The system of claim 16, wherein said at least one module is operable to provide a user interface by, at least in part, operating to provide a user interface by which a user may input characteristics of advertising content desired by the user.

19. The system of claim 16, wherein said at least one module is operable to provide a user interface by, at least in part, operating to provide a user interface by which a user may input characteristics of advertising content that is not desired by the user.

20. The system of claim 16, wherein said input characteristics of advertising content comprise information identifying a specific product.

21. The system of claim 16, wherein said input characteristics of advertising content comprise information identifying a type of product.

22. The system of claim 16, wherein said input characteristics of advertising content comprise information identifying a particular product source.

23. The system of claim 16, wherein said input characteristics of advertising content comprise information identifying a style of advertising content.

24. The system of claim 16, wherein said input characteristics of advertising content comprise information identifying a particular advertisement.

25. The system of claim 24, wherein said at least one module is operable to provide a user interface by which a user may input characteristics of advertising content by, at least in part, operating to provide a user interface by which a user may flag advertising content that is presently being presented.

26. The system of claim 16, wherein said at least one module is operable to provide a user interface by which a user may input characteristics of advertising content by, at least in part, operating to provide a user interface by which a user may specify a time window associated with advertising content.

27. The system of claim 26, wherein said at least one module is operable to time-shift advertising content based, at least in part, on the user-specified time window.

28. The system of claim 16, wherein said at least one module is operable to prioritize advertising content based, at least in part, on the input characteristics.

29. The system of claim 16, wherein said at least one module is operable to select advertising by, at least in part, operating to replace received advertising content that does not conform to user-specified characteristics with advertising that conforms to user-specified characteristics.

30. The system of claim 16, wherein said at least one module is operable to select advertising by, at least in part, operating to override user-defined advertising content restrictions.
